(19) United States
(12) Patent Application Publication
(10) Pub. No.: US 2026/0084885 A1
(43) Pub. Date: Mar. 26, 2026

(54) DEFROSTING CONTAINER FOR FROZEN SUSHI

(71) Applicant: KABUSHIKI KAISHA B&T MARINE PRODUCTS COMPANY, Chuo-ku Tokyo (JP)

(72) Inventor: Tsutomu SUZUKI, Tokyo (JP)

(73) Assignee: KABUSHIKI KAISHA B&T MARINE PRODUCTS COMPANY, Chuo-ku Tokyo (JP)

(21) Appl. No.: 18/876,479

(22) PCT Filed: Oct. 10, 2023
(86) PCT No.: PCT/JP2023/036777

§ 371 Date: Dec. 2, 2025

(30) Foreign Application Priority Data
Dec. 26, 2022 (JP) 2022-209055

(51) Int. Cl. B65D 81/34; A23B 2/82

(52) U.S. Cl. CPC B65D 81/3453; A23B 2/82

(57) ABSTRACT

The present invention provides a defrosting container with a simple structure that can be manufactured inexpensively and that can stably achieve desirable defrosting of frozen sushi and a preparation method for the frozen sushi using the defrosting container. A defrosting container (1) for frozen sushi includes: a lid member (2); an intermediate bottom member (3) on which the frozen sushi is disposed with a sushi topping placed above; and a lower bottom member (4) that can accommodate water, wherein heating with a microwave oven is performed in a state in which water (6) is accommodated under the intermediate bottom member with which sushi rice of the frozen sushi (5) is in contact. The preparation method includes a step of pouring water in the lower bottom member (4) to achieve a state in which the water (6) is accommodated under the intermediate bottom member (3) with which the sushi rice of the frozen sushi (5) is in contact; and a step of heating the frozen sushi contained in the defrosting container (1) in a state in which water is poured in the lower bottom member with a microwave oven.

### TECHNICAL FIELD

The present invention relates to a defrosting container for frozen sushi, frozen sushi contained in a defrosting container, and a preparation method for frozen sushi.

### BACKGROUND ART

In the past, in order to improve eating quality of frozen sushi, which is eaten after defrosting, various techniques have been reported. Most of such techniques use a container having a means for shielding microwaves from a microwave oven locally disposed, the container being configured in such a way that microwaves applied to a sushi topping are attenuated compared to microwaves applied to sushi rice (Patent Literature 1 and Patent Literature 2).

Patent Literature 1 proposes a defrosting container that includes a magnetic shielding member, the magnetic shielding member including a water container made of synthetic resin and water poured in the water container, wherein the magnetic shielding member is disposed in such a way as to cover an upper side and upper side faces of frozen sushi arranged with a sushi topping placed above (for example, in claim 1 and FIG. 5).

Patent Literature 2 proposes a defrosting container that includes a main container including a lid member and a vessel, an insert, and an intermediate container, wherein a shielding member for shielding microwaves is provided inside an upper face and side faces of the lid member, and when defrosting frozen sushi placed on the insert in the intermediate container with a sushi topping placed above, microwaves are irradiated only from a lower part of the vessel (for example, in claim 1 and FIG. 3).

### CITATION LIST

### Patent Literature

Patent Literature 1: JP 3640473 B
Patent Literature 2: JP 2007-137493 A

### SUMMARY OF INVENTION

### Technical Problem

In order to provide the microwave shielding member on an upper side or side faces of the container, the container is required to have an unusual shape or include an additional material such as aluminum foil, which is a factor that exerts pressure on a material cost or a processing cost of the defrosting container for which mass production is required in order to achieve practical use. Therefore, a defrosting container with a simple structure that can be manufactured inexpensively and that can stably achieve desirable defrosting of frozen sushi has been desired.

### Solution to Problem

The inventor has earnestly considered a defrosting container while staying away from stereotypical views that microwaves must be locally shielded for appropriate defrosting of frozen sushi, and has surprisingly found that frozen sushi with good eating quality can be provided by heating the frozen sushi with a microwave oven under presence of a proper amount of water that is properly disposed, and has achieved the present invention.

In other words, the present invention provides a defrosting container for frozen sushi that includes a lid member, an intermediate bottom member on which the frozen sushi is disposed with a sushi topping placed above, and a lower bottom member that can accommodate water, wherein heating with a microwave oven is performed in a state in which water is accommodated under the intermediate bottom member with which sushi rice of the frozen sushi is in contact. The defrosting container for frozen sushi according to the present invention does not require a microwave shielding member.

The lid member and the intermediate bottom member are preferably configured to fit each other.

In the intermediate bottom member, fine pores through which steam derived from heated water heated with the microwave oven can pass through are preferably provided.

When the intermediate bottom member and the lower bottom member are fit each other, a space that can accommodate a sufficient amount of water is preferably formed between the intermediate bottom member and the lower bottom member in such a way as to prevent water from boiling due to heating with the microwave oven.

In a case in which frozen sushi to be disposed on the intermediate bottom member is nigiri sushi, a convex portion is provided according to the number of pieces of the nigiri sushi, and the convex portion preferably has a height sufficient for keeping a state in which an edge of the sushi topping is not in contact with a bottom of the intermediate bottom member.

The present invention further provides frozen sushi contained in a defrosting container, the defrosting container including a lid member, an intermediate bottom member on which the frozen sushi is disposed with a sushi topping placed above, and a lower bottom member that can accommodate water, wherein heating with a microwave oven is performed in a state in which water is accommodated under the intermediate bottom member with which sushi rice of the frozen sushi is in contact. The frozen sushi contained in the defrosting container according to the present invention does not require a microwave shielding member.

The present invention further provides a preparation method for frozen sushi contained in a defrosting container, the defrosting container including a lid member, an intermediate bottom member on which the frozen sushi is disposed with a sushi topping placed above, and a lower bottom member that can accommodate water, the method including: a step of pouring water in the lower bottom member to achieve a state in which water is accommodated under the intermediate bottom member with which sushi rice of the frozen sushi is in contact; and a step of heating the frozen sushi contained in the defrosting container in a state in which water is poured in the lower bottom member with a microwave oven. The preparation method for the frozen sushi contained in the defrosting container according to the present invention does not require a microwave shielding member.

The present invention further provides a preparation method for frozen sushi contained in a defrosting container, the defrosting container including a lid member and a bottom member on which the frozen sushi is disposed with a sushi topping placed above, the method including: a step of pouring water in a water-retaining container that can accommodate water; a step of placing the frozen sushi contained in the defrosting container above the water-retaining container to achieve a state in which water is accommodated under the bottom member with which sushi rice of the frozen sushi is in contact; and a step of heating the water-retaining container in which water is poured and the frozen sushi contained in the defrosting container with a microwave oven. The preparation method for the frozen sushi contained in the defrosting container according to the present invention does not require a microwave shielding member.

### Advantageous Effects of Invention

The defrosting container for frozen sushi according to the present invention has a simple structure that can be manufactured inexpensively and has high suitability for mass production.

In addition, since the defrosting container for frozen sushi according to the present invention can stably achieve desirable defrosting of frozen sushi, enabling sushi with good eating quality to be reproducibly used at home or the like.

The frozen sushi contained in the defrosting container according to the present invention is suitable for delivery, storage and sales in a frozen state, enabling a supply chain for frozen sushi to be streamlined. In addition, the defrosting container for frozen sushi according to the present invention may be a solution for shortage of sushi chefs.

In addition, since the frozen sushi contained in the defrosting container according to the present invention can be directly heated and prepared just by putting the frozen sushi contained in the defrosting container in a state in which water is accommodated in the defrosting container, high level of convenience can be provided to a defrosting operator or a consumer.

The preparation method for the frozen sushi according to the present invention enables sushi with good eating quality to be prepared by putting the frozen sushi contained in the defrosting container in a state in which water is accommodated under the sushi rice and a simple operation of heating with a microwave oven.

### BRIEF DESCRIPTION OF DRAWINGS

FIG. 1 is a top view illustrating a defrosting container of an embodiment according to the present invention in a state in which frozen sushi is disposed in the defrosting container and a lid member is removed.

FIG. 2 is a sectional view of the defrosting container of the embodiment illustrated in FIG. 1 taken along line A-A.

FIG. 3 is a sectional view of the defrosting container of the embodiment illustrated in FIG. 1 taken along line B-B. Illustrated here is a state in which the lid member is attached and water is poured in the lower bottom member.

### DESCRIPTION OF EMBODIMENTS

A subject for the present invention, that is, “sushi” includes nigiri sushi, warship roll, pressed sushi, and rod-shaped pressed sushi, but is not limited to these as long as a sushi topping is placed on top of sushi rice. For the sushi rice, common vinegared rice obtained by mixing rice with vinegar can be used. Subjects for a sushi topping are not limited, and include, as examples, fish and seafood such as tuna, squid, salmon, yellowtail, shrimp, and flatfish.

In the present description, “sushi with good eating quality” refers to sushi in which sushi rice has a temperature that may give appropriate warmth, and a sushi topping has a temperature slightly lower than that of the sushi rice, and such sushi falls under the category of so-called “ready to eat”. Specifically, the temperature of the sushi rice is preferably approximately 30° C. to 45° C. and the temperature of the sushi topping is preferably approximately 18° C. to 25° C.

### Defrosting Container for Frozen Sushi

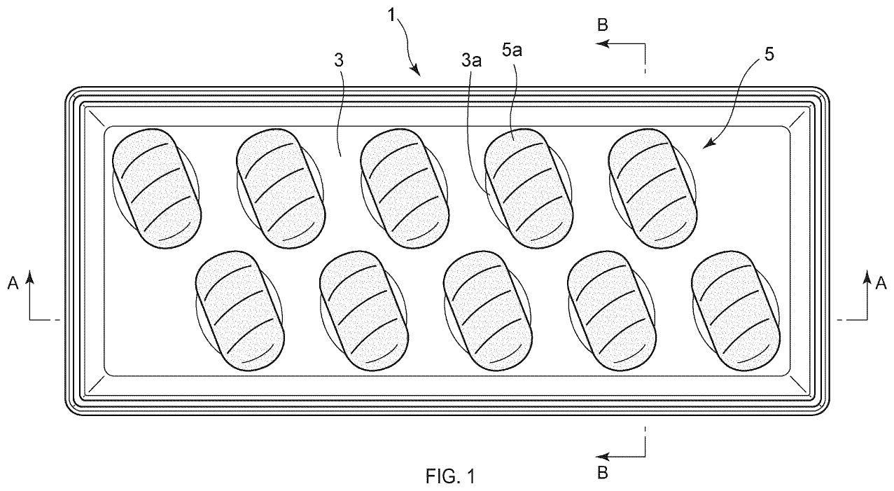

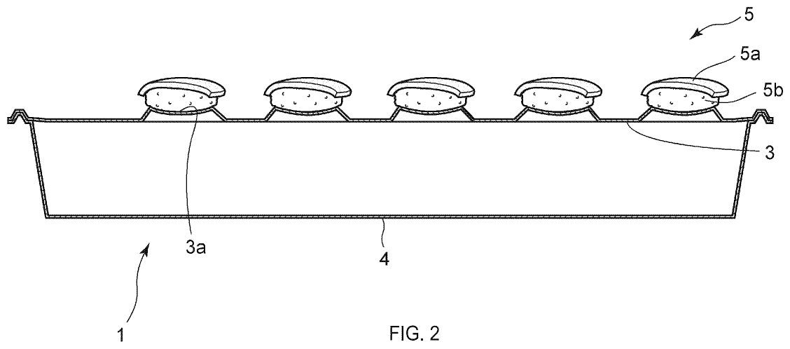

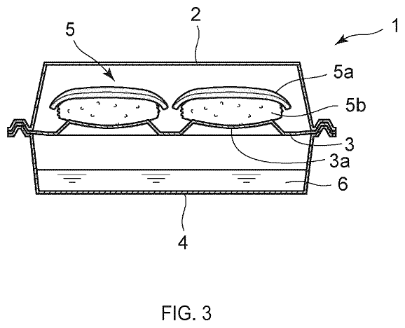

A defrosting container 1 illustrated in FIG. 1 to FIG. 3 includes a lid member 2 (illustrated only in FIG. 3), an intermediate bottom member 3, and a lower bottom member 4. On the intermediate bottom member 3, frozen sushi 5 is disposed in a state in which a sushi topping 5a is placed on top of sushi rice 5b. The lower bottom member 4 has a structure that can accommodate water, and by pouring water therein, water 6 is accommodated under the frozen sushi 5. By heating the defrosting container 1 with a microwave oven in a state in which the water 6 is accommodated, sushi with good eating quality can be obtained.

A reason why such desirable defrosting of the frozen sushi 5 can be achieved by using the defrosting container 1 is, although not restricted to a specific theory, assumed as described below. It is considered that the water 6 is heated before the frozen sushi 5 by heating the frozen sushi 5 and the water 6 in a double-layered structure in a unified manner since defrosting with a microwave oven has a characteristic that “heat is first concentrated on a position where ice turns into water” and as a result, concentration of heat on the frozen sushi 5 is prevented and the frozen sushi 5 is slowly heated, and thus, the sushi topping 5a in particular may be prevented from being overheated and boiled. It is also considered that in addition to heat caused by microwaves from the microwave oven, heat from the temperature of hot water obtained by heating the water 6 disposed under the sushi rice 5b is transferred to the sushi rice 5b, and consequently the temperature of the sushi rice 5b increases further than that of the sushi topping 5a, and a ready to eat state in which difference in temperature between the sushi rice 5b and the sushi topping 5a is appropriate can be achieved.

As a material of the defrosting container, any material can be employed as long as the material allows microwaves to transmit and is constructed of a heat-resistant material that can withstand heating with the microwave oven. Specifically, the material includes polyethylene, polypropylene, polycarbonate, polyester, nylon, paper, and paper coated with the aforementioned polymer. A dimension of the defrosting container is selected principally according to a size of the frozen sushi 5 disposed on the intermediate bottom member 3 and the number of pieces of the frozen sushi 5. The defrosting container preferably has a dimension that enables rotation in the microwave oven. FIG. 1 illustrates a container for one person in which 10 pieces (10 kan) of nigiri sushi are disposed.

The lid member 2 and the intermediate bottom member 3 are preferably configured to fit each other in such a way that the frozen sushi 5 disposed inside is suitable for delivery, storage, display, or the like. The lower bottom member 4 is preferably configured to fit one or both of the lid member 2 and the intermediate bottom member 3 in such a way that these three members can be carried in an integrated manner. It is more preferable that the lid member 2 and the intermediate bottom member 3 are configured to fit each other and in addition, the intermediate bottom member 3 and the lower bottom member 4 are configured to fit each other in such a way that these three members can be carried in an integrated manner.

In the intermediate bottom member 3, fine pores through which steam derived from heated water heated with the microwave oven can pass through are preferably provided. The fine pores are preferably provided in an arrangement region of the intermediate bottom member 3 where the frozen sushi 5 is disposed in such a way that heat and the steam from the hot water is more easily transferred to the sushi rice 5b. The fine pores are more preferably provided substantially only in the arrangement region of the intermediate bottom member 3 where the frozen sushi 5 is disposed. The “arrangement region” where the frozen sushi 5 is disposed means a region obtained by projecting the sushi rice 5b onto the intermediate bottom member 3 placed horizontally from above. The phrase “substantially only in” means that a ratio of a total area occupied by the fine pores provided in the arrangement region to a total area of all the fine pores provided in the intermediate bottom member 3 is 90% or more, preferably 95% or more, or more preferably 98% or more.

When the intermediate bottom member 3 and the lower bottom member 4 are fit each other, a space that can accommodate a sufficient amount of the water 6 is preferably formed between the intermediate bottom member 3 and the lower bottom member 4 in such a way as to prevent water from boiling due to heating with the microwave oven. Therefore, a shape of the lower bottom member 4 in particular is preferably designed relative to a shape of a bottom of the intermediate bottom member 3 in such a way that an amount of space sufficient for accommodating an amount of the water 6 that is assumed to be proper may be formed therebetween.

The temperature of water after desired heating with the microwave oven is completed is typically approximately 60° C. to 80° C. Therefore, the proper amount for the water 6 has a certain range, and in order to achieve desirable defrosting of the frozen sushi 5, it is important for the defrosting operator to understand the range of the proper amount. Specifically, the proper amount for the water 6 is defined principally according to a size of the frozen sushi 5 disposed in the defrosting container 1 and the number of pieces of the frozen sushi 5.

A water inlet for pouring water may be provided in an upper part of a side face of the lower bottom member 4. By providing the water inlet, an operation of temporarily disassembling the intermediate bottom member 3 and the lower bottom member 4 that have been fit in advance before pouring water in the lower bottom member 4 may be omitted. In order to simplify an operation of pouring water, the side face of the lower bottom member 4 may have a bulging overhang section in an upper part and the water inlet may be provided in an upper surface of the overhang section.

On the side face of the lower bottom member 4, a graduation line serving as an indication of the proper amount for the water 6 may be provided by printing or with an indentation in the container. The graduation line may be a pair of lines that indicate a substantially upper limit and a substantially lower limit for the proper amount, or maybe a single line that indicates a typical amount for the proper amount.

In a case in which the frozen sushi 5 to be disposed on the intermediate bottom member 3 is nigiri sushi, a convex portion 3a may be provided according to the number of pieces of the frozen sushi 5. The convex portion 3a preferably has a height sufficient for keeping a state in which an edge of the sushi topping 5a is not in contact with the bottom of the intermediate bottom member 3. When the frozen sushi 5 is heated by microwaves from the microwave oven in a state in which the edge of the sushi topping 5a is in contact with the bottom of the intermediate bottom member 3, a portion of the sushi topping 5a in contact with the bottom of the intermediate bottom member 3 is antecedently defrosted, leading to accumulation of water in the portion, and microwaves are concentrated on the accumulated water, which is likely to be an origin of overheating of the sushi topping 5a. Therefore, by providing the convex portion 3a that raises the nigiri sushi, a highly favorable effect of preventing the sushi topping 5a overhanging on both sides of the sushi rice 5b in particular from being overheated can be achieved, and desirable defrosting can be more stably achieved. In addition, by providing the convex portion 3a, an effect that voluminous look of the sushi is enhanced and an effect that the sushi can be easily removed by picking up the sushi with chopsticks can be achieved.

When the convex portion 3a is provided, an upper surface thereof preferably has a downwardly curved shape in such a way that the upper surface more closely adheres to an underside of the sushi rice 5b. Because of the curved shape, the frozen sushi 5 or the defrosted sushi may be held more stably in the container.

When fine pores through which steam derived from water can pass through are provided in the intermediate bottom member 3 having the convex portion 3a, the fine pores are preferably provided in the upper surface of the convex portion 3a, and more preferably provided substantially only in the upper surface of the convex portion 3a. The fine pores are preferably provided in a region where the upper surface of the convex portion 3a overlaps with the arrangement region where the frozen sushi 5 is disposed, and more preferably provided substantially only in the region where the upper surface of the convex portion 3a overlaps with the arrangement region where the frozen sushi 5 is disposed. The meaning of the “arrangement region” where the frozen sushi 5 is disposed and the meaning of the phrase “substantially only in”are as described above.

### Preparation Method for Frozen Sushi

A preparation method for serving the frozen sushi 5 contained in the defrosting container 1 for eating provided by the present invention may be executed by pouring water in the lower bottom member 4 to achieve a state in which the water 6 is accommodated under the intermediate bottom member 3 with which the sushi rice 5b of the frozen sushi 5 is in contact, and subsequently heating the frozen sushi 5 contained in the defrosting container 1 in which water is poured in the lower bottom member 4 and on which the lid member 2 is placed with a microwave oven. By temporarily disassembling the intermediate bottom member 3 and the lower bottom member 4, water may be poured in the lower bottom member 4; however, when the water inlet is provided in the lower bottom member 4 as described above, water may be poured through the water inlet.

Time required for heating with the microwave oven is selected principally according to a power of the used microwave oven and a size of the frozen sushi 5 disposed on the intermediate bottom member 3 and the number of pieces of the frozen sushi 5. For example, for preparing a container for one person in which 10 pieces of nigiri sushi are disposed (box of sushi) with a power of 500 W (watts), heating time is preferably approximately 90 to 120 seconds. After heating is completed, the defrosted frozen sushi 5 may be directly served for eating without the need for securing time to leave the frozen sushi 5 and adjust the temperature or the like.

It is preferred that operation instructions are reliably communicated to the defrosting operator by describing information on a preparation condition for a combination of appropriate heating time to be set and a power of the microwave oven together with an instruction that a proper amount of water must be poured in the lower bottom member 4 before heating with the microwave oven as operation instructions on a package for the defrosting container 1 or attaching an operating instruction manual describing the operation instructions when the frozen sushi 5 contained in the defrosting container 1 is sold. In this manner, the frozen sushi 5 may be reproducibly prepared at home and one can enjoy sushi with good eating quality.

A principle of the preparation method described above does not apply only to frozen sushi contained in an integrated defrosting container including the lid member, the intermediate bottom member, and the lower bottom member, and may be applied to a defrosting container constructed from separate structures, that is, a structure in which frozen sushi is disposed and stored and a structure that accommodates water.

In other words, the present invention also provides, in an alternative embodiment, a preparation method for frozen sushi contained in a defrosting container, the defrosting container including a lid member and a bottom member on which the frozen sushi is disposed with a sushi topping placed above. A water-retaining container that can accommodate water is separately provided. The preparation method for frozen sushi may be executed by pouring water in the water-retaining container and placing the frozen sushi contained in the defrosting container on which the lid member is placed above the water-retaining container, thus achieving a state in which water is accommodated under the bottom member with which sushi rice of the frozen sushi is in contact, and subsequently heating the water-retaining container in which water is poured and the frozen sushi contained in the defrosting container with a microwave oven.

It should be noted that a preferable configuration of the integrated defrosting container described above, for example, configurations of the fine pores and the convex portion may be applied to the structure including the lid member and the bottom member of the defrosting container constructed from separate structures as necessary.

The water-retaining container may be a structure that can accommodate water and can be hermetically closed, for example, a capped container. In this case, an upper section of the water-retaining container is preferably substantially planar with an area equal to or larger than that of the bottom of the defrosting container in such a way that the defrosting container can be stably placed above the water-retaining container.

The water-retaining container may be a structure with an opening that can accommodate water. In this case, a structure for preventing the defrosting container from being submerged in the water accommodated in the water-retaining container is required. For example, the water-retaining container may include, as part thereof, a supporting base including a base member and a leg member that can keep a certain distance between a surface of the water accommodated in the water-retaining container and an underside of the bottom member of the defrosting container.

In each of the structure that can be hermetically closed and the structure with the opening, a graduation line serving as an indication of a proper amount for water, similarly to the one as described above with respect to the lower bottom member 4, may be provided on a side face of the water-retaining container. For application to a plurality of types of the defrosting containers in which the sizes of the disposed frozen sushi are different and/or the numbers of pieces of the frozen sushi are different, a plurality of types of graduation lines may be provided in the water-retaining container. For example, providing “a graduation line for water volume when eight pieces of nigiri sushi are heated” and “a graduation line for water volume when 12 pieces of nigiri sushi are heated”together, or the like is conceivable.

According to the preparation method in the alternative embodiment according to the present invention, when the number of or the types of the defrosting containers containing the frozen sushi to be prepared, the defrosting container including the lid member and the bottom member, is more than one, the preparation method for the frozen sushi may be executed by repeatedly using a fewer number of the water-retaining container, for example, a single container. Therefore, when preparation of a lot of frozen sushi contained in defrosting containers is desired to be performed efficiently in a professional application or the like, the water-retaining container may be preferably used.

### Supplementary Note

The present description further discloses supplementary notes to be described below in relation to the description described above.
[1] A defrosting container for frozen sushi including: a lid member; an intermediate bottom member on which the frozen sushi is disposed with a sushi topping placed above; and a lower bottom member that can accommodate water, wherein heating with a microwave oven is performed in a state in which water is accommodated under the intermediate bottom member with which sushi rice of the frozen sushi is in contact.
[2] The defrosting container for frozen sushi according to supplementary note [1], wherein the lid member and the intermediate bottom member are configured to fit each other.
[3] The defrosting container for frozen sushi according to supplementary note [1] or [2], wherein in the intermediate bottom member, fine pores through which steam derived from heated water heated with the microwave oven can pass through are provided.
[4] The defrosting container for frozen sushi according to any one of supplementary notes [1] to [3], wherein the intermediate bottom member and the lower bottom member are configured, when the intermediate bottom member and the lower bottom member are fit each other, in such a way that a space that can accommodate a sufficient amount of water is formed between the intermediate bottom member and the lower bottom member in such a way as to prevent water from boiling due to heating with the microwave oven.
[5] The defrosting container for frozen sushi according to any one of supplementary notes [1] to [4], wherein in a case in which frozen sushi to be disposed on the intermediate bottom member is nigiri sushi, a convex portion is provided according to the number of pieces of the nigiri sushi, and the convex portion has a height sufficient for keeping a state in which an edge of the sushi topping is not in contact with a bottom of the intermediate bottom member.
[6] Frozen sushi contained in the defrosting container according to any one of supplementary notes [1] to [5], wherein the frozen sushi is disposed with a sushi topping placed above on the intermediate bottom member.
[7] Frozen sushi contained in a defrosting container, the defrosting container including a lid member, an intermediate bottom member on which the frozen sushi is disposed with a sushi topping placed above, and a lower bottom member that can accommodate water, wherein heating with a microwave oven is performed in a state in which water is accommodated under the intermediate bottom member with which sushi rice of the frozen sushi is in contact.
[8] A preparation method for frozen sushi contained in the defrosting container according to any one of supplementary notes [1] to [5], wherein the frozen sushi is disposed with a sushi topping placed above on the intermediate bottom member, the method including: a step of pouring water in the lower bottom member to achieve a state in which water is accommodated under the intermediate bottom member with which sushi rice of the frozen sushi is in contact; and a step of heating the frozen sushi contained in the defrosting container in a state in which water is poured in the lower bottom member with a microwave oven.
[9] A preparation method for frozen sushi contained in a defrosting container, the defrosting container including a lid member, an intermediate bottom member on which the frozen sushi is disposed with a sushi topping placed above, and a lower bottom member that can accommodate water, the method including: a step of pouring water in the lower bottom member to achieve a state in which water is accommodated under the intermediate bottom member with which sushi rice of the frozen sushi is in contact; and a step of heating the frozen sushi contained in the defrosting container in a state in which water is poured in the lower bottom member with a microwave oven.
[10] A preparation method for frozen sushi contained in a defrosting container, the defrosting container including a lid member and a bottom member on which the frozen sushi is disposed with a sushi topping placed above, the method including: a step of pouring water in a water-retaining container that can accommodate water; a step of placing the frozen sushi contained in the defrosting container above the water-retaining container to achieve a state in which water is accommodated under the bottom member with which sushi rice of the frozen sushi is in contact; and a step of heating the water-retaining container in which water is poured and the frozen sushi contained in the defrosting container with a microwave oven.
[11] The preparation method for frozen sushi according to supplementary note [10], wherein in the defrosting container, the lid member and the bottom member are configured to fit each other.
[12] The preparation method for frozen sushi according to supplementary note [10] or [11], wherein in a case in which frozen sushi to be disposed on the bottom member of the defrosting container is nigiri sushi, a convex portion is provided according to the number of pieces of the nigiri sushi, and the convex portion has a height sufficient for keeping a state in which an edge of the sushi topping is not in contact with a bottom of the bottom member.

### REFERENCE SIGNS LIST

1 defrosting container
2 lid member
3 intermediate bottom member
3a convex portion
4 lower bottom member
5 frozen sushi
5a sushi topping
5b sushi rice
6 water

1. A defrosting container for frozen sushi comprising:
a lid member;
an intermediate bottom member on which the frozen sushi is disposed with a sushi topping placed above; and
a lower bottom member that can accommodate water, wherein heating with a microwave oven is performed in a state in which water is accommodated under the intermediate bottom member with which sushi rice of the frozen sushi is in contact.

2. The defrosting container for frozen sushi according to claim 1, wherein the lid member and the intermediate bottom member are configured to fit each other.

3. The defrosting container for frozen sushi according to claim 1, wherein in the intermediate bottom member, fine pores through which steam derived from heated water heated with the microwave oven can pass through are provided.

4. The defrosting container for frozen sushi according to claim 1, wherein the intermediate bottom member and the lower bottom member are configured, when the intermediate bottom member and the lower bottom member are fit each other, in such a way that a space that can accommodate a sufficient amount of water is formed between the intermediate bottom member and the lower bottom member in such a way as to prevent water from boiling due to heating with the microwave oven.

5. The defrosting container for frozen sushi according to claim 1, wherein in a case in which frozen sushi to be disposed on the intermediate bottom member is nigiri sushi, a convex portion is provided according to the number of pieces of the nigiri sushi, and the convex portion has a height sufficient for keeping a state in which an edge of the sushi topping is not in contact with a bottom of the intermediate bottom member.

6. Frozen sushi contained in a defrosting container, the defrosting container including a lid member, an intermediate bottom member on which the frozen sushi is disposed with a sushi topping placed above, and a lower bottom member that can accommodate water, wherein heating with a microwave oven is performed in a state in which water is accommodated under the intermediate bottom member with which sushi rice of the frozen sushi is in contact.

7. A preparation method for frozen sushi contained in a defrosting container, the defrosting container including a lid member, an intermediate bottom member on which the frozen sushi is disposed with a sushi topping placed above, and a lower bottom member that can accommodate water, the method comprising:
a step of pouring water in the lower bottom member to achieve a state in which water is accommodated under the intermediate bottom member with which sushi rice of the frozen sushi is in contact; and
a step of heating the frozen sushi contained in the defrosting container in a state in which water is poured in the lower bottom member with a microwave oven.

8. A preparation method for frozen sushi contained in a defrosting container, the defrosting container including a lid member and a bottom member on which the frozen sushi is disposed with a sushi topping placed above, the method comprising:
a step of pouring water in a water-retaining container that can accommodate water;
a step of placing the frozen sushi contained in the defrosting container above the water-retaining container to achieve a state in which water is accommodated under the bottom member with which sushi rice of the frozen sushi is in contact; and
a step of heating the water-retaining container in which water is poured and the frozen sushi contained in the defrosting container with a microwave oven.
